(19) United States
(12) Patent Application Publication
(10) Pub. No.: US 2003/0084068 A1
(43) Pub. Date: May 1, 2003

(54) Method and system for providing control marks on a document

(76) Inventor: James L. Harman, Southport, CT (US)

Correspondence Address: PITNEY BOWES INC., 35 WATERVIEW DRIVE, P.O. BOX 3000, MSC 26-22, SHELTON, CT, 06484-8000, US

(21) Appl. No.: 09/682,898

(22) Filed: Oct. 30, 2001

(51) Int. Cl. G06F 12/00

(52) U.S. Cl. 707/200

(57) ABSTRACT

A method and system for reformatting a file and adding control indicia to the file for use in a document finishing system is described. A setup process used to define import parameters that are used to extract information from a print stream, a report template and control code parameters to determine appropriate codes. A runtime process is used to reformat the input file and modify it to include control indicia as a new print stream. The setup process utilizes a series of prompts for information based upon the document finishing system used.

### CROSS REFERENCE TO RELATED APPLICATIONS

The present application is related to U.S. patent application Ser. No.: 09/471,764, filed Dec. 23, 1999, entitled A Method and System for Reformatting a Text File, which is incorporated herein by reference in its entirety.

### BACKGROUND OF INVENTION

The embodiments described herein may be useful in file manipulation systems and more specifically to systems for modifying a print stream to include control indicia using parameter tables to control the print stream modification.

Many document handling and mail piece processing systems are capable of utilizing Optical Mark Recognition (OMR) indicia located on a work piece to control functions of the system. The indicia may be an OMR bar code that may use location to encode information. Other bar codes using different formats including those with start and stop characters may be utilized.

For example, many folder/inserters for finishing batches of mail pieces include OMR mark detection scanners that detect OMR control marks that are then utilized in the control of certain aspects of the operation of the folder/inserter. Sheets of paper that are to be folded and inserted into an envelope have control indicia such as printed OMR marks that may control whether a particular insert is added to the collation and to ensure a proper collation is inserted into the mail piece envelope. For example, the bar code is read by a scanner and interpreted by a processor that uses the information to control certain functions such as monitoring the beginning and end of each set or collation of pages to be inserted. Other features may include the triggering of selective operation of auxiliary feeders and may include forcing the inserter to stop or divert certain mail pieces. The accuracy of the output stream may be enhanced by the use of sequence counter indicia that may aid in the detection of missing, duplicated or out of order pages.

Many software packages that generate documents that are to be folded and inserted into envelopes do not include the ability to insert OMR codes or other control indicia into the output file. Furthermore, packages that do provide some OMR capability may not be flexible such that various control protocols may be utilized in order to support multiple mail piece finishing systems or applications such as selective feeding.

Many data processing systems often produce, or require, an ASCII or similar text or print file as output. Such data processing systems generate documents for use in a variety of commercial activities. For example, such documents include purchase and sale invoices, medical bills, activity accounting, and performance reports. It is often required that these documents, once generated and printed to a hard copy, be transmitted through the postal system. The documents are often printed on pre-printed forms that include graphical and/or other content that is common to each of a type of document. Such pre-printed forms may be costly to acquire and inventory.

Data processing systems that generate a text file output that is sent to a printer for printing generally replicate the exact layout of the text file according to typewriter end of line commands or other ASCII command characters for such functions as print positioning and end of page (form feed). Others may utilize font and formatting information. The result is a stack of paper printouts that cannot be altered or manipulated, unless the user manually reformats the original text file and again reprints the file for each document. Furthermore, these files do not include font or graphics information. Thus, if a user wishes to print a logo or other graphics information pre-printed forms must be used.

One example of a type of such document production system is a system used for billing and reporting in medical offices. During an office visit, or sometime afterward, a medical office employee typically enters information about the visit in an accounting program. A billing report is typically generated at the end of a month and usually includes the patient's name, billing address, the specific services performed, the cost of the services and the date of the visit. If the same patient visits the same doctor a new text file is created representing the second visit. The bills are then sent to a text printer for printing on a pre-printed form, which may include common content such as the doctor's name, and return address and any desired graphic information.

There may be problems associated with such a system. If the bill contains many entries for services performed it may be required to be printed on several pages. If an automatic folder/inserter is utilized, it may not be able to discern the beginning of the next document unless such data is provided to the folder/inserter. If the bill is over a certain page limit, the automated finishing equipment may not be able to process it properly. Furthermore, if the doctor wishes to alter the design of the document or any text contained thereon, the change must be made in the original accounting program that may not allow output modification. A change in the common pre-printed stock will usually result in the waste of remaining stock of pre-printed forms. If the change is a uniform change to be made on each document, then every document must be reprinted. Customization of accounting programs may be time consuming and costly and result in a system that may not be upgradeable.

Such text file systems may not support or automatically take advantage of address quality programs and/or document finishing systems that may provide postal discount qualifications and prepare mail for delivery into the postal stream using control codes. Similarly, such text file based systems may not support OMR control codes for controlling finishing equipment.

### SUMMARY OF INVENTION

In one embodiment, an output file processing system receives setup parameters that include import parameters to control the import process that may include a file type parameter. The system receives output file report layout parameters and may receive output file modification parameters. The system may provide test reports and may process a test input stream of test output files. The system stores at least one set of parameters.

In another embodiment, the system processes an input print stream of original application data output files according to import parameters into an import database.

In another embodiment, the system processes the import database according to report layout and modification parameters to produce an output report.

### BRIEF DESCRIPTION OF DRAWINGS

FIG. 1 is a system block diagram showing a network of components utilized in an embodiment of the present application.

FIG. 2 is a block diagram of an embodiment of a reformatting system according to the present application.

FIGS. 3A 3C are block diagrams of an embodiment of a reformatting system setup process according to the present application.

FIG. 4 is a flow chart showing the setup process of an embodiment of a reformatting system according to the present application.

FIG. 5 is a flow chart of the import process of an embodiment of a reformatting system according to the present application.

FIG. 6 is a flow chart of the report generation process of an embodiment of a reformatting system according to the present application.

### DETAILED DESCRIPTION

The present application describes embodiments of a system and method for providing control indicia in a file. The embodiments are illustrative and where alternative elements are described, they are understood to fully describe alternative embodiments without repeating common elements. The processes described provide useful results including but not limited to increasing mail piece handling accuracy, mail piece customization capability, mail piece throughput and sorting capability by using an easy to learn and use interface that provides expeditious setup and decreased processing time.

The embodiments described herein utilize a data processing system including a Microsoft Windows NT compatible platform such as a Gateway E-4200 Pentium III based computer running the Microsoft Windows NT 4 operating system and Microsoft Access 2000 database and reporting software. As can be appreciated, the processes described herein may alternatively be implemented on different platforms and with different development tools. Alternatives may include different operating systems such as other Microsoft Windows operating systems, Unix and Mac OS. Similarly, different hardware systems may be utilized including Windows/Intel compatible (including IBM PC Compatible), Sun Microsystems systems, Apple systems, Alpha based systems and other processing systems such as mainframe and minicomputers including the IBM AS 400. The original document generating system may include the same platforms such as an IBM AS 400.

Several processes are implemented in Visual Basic for Applications (VBA). Alternatives include many other known programming languages and development systems including Seagate Crystal Reports available from Crystal Decisions, Inc., Visual Basic, C and C++. In such systems, Microsoft Access may not be required.

The system in one embodiment incorporates a PC compatible computer connected to a network for receiving input files that were output from a data processing program. The system is preferably connected by a communications link to a printer or set of printers that are used to print pages to be processed by a folder/inserter system. However, it is to be understood that different data processors and communications channels may be utilized.

The various embodiments described may be utilized with one or more document handling systems such as mail piece finishing systems marketed by Pitney Bowes Inc. including DOCUMATCH®, the 3 Series™ Desktop Inserting System and the 5 Series™ Tabletop Inserting System. As can be appreciated, the system may be modified to be compatible with additional document handling systems. Similarly, certain systems such as DOCUMATCH may require a print stream with embedded control information and others such as the 5 Series Tabletop Inserting System may utilize Optical Mark Recognition (OMR) control Codes on the mail piece.

The various embodiments described may be utilized with one or more postal sort code and address cleansing and/or sorting systems such as FINALIST® and SMARTMAILER® that are available from Pitney Bowes Inc.

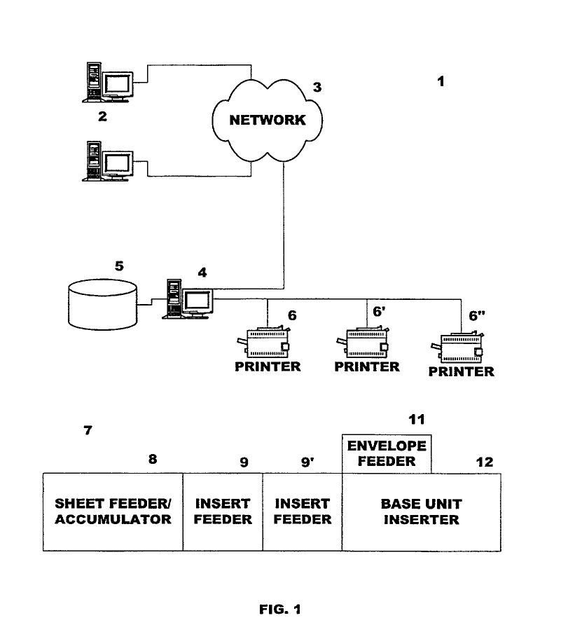

Referring to FIG. 1, a first embodiment is described. A mail piece generation system 1 includes an original document source 2 and a network or communications channel 3 for providing print stream or other output to the system for reformatting an ASCII or similar text file 4. The resulting data may be modified to include OMR codes, otherwise manipulated, enhanced and/or postal coded. Setup and intermediate data may be stored in storage device 5. The modified print stream is sent to a printer or printers 6, 6′, 6″ and the printed collations are fed into inserter system 7 for processing into a mail piece. The representative inserter 7 includes a sheet feeder/accumulator 8, insert feeders 9 and 9′ and base unit inserter 1 2 having envelope feeder 11. Many other configurations are possible.

In this embodiment, the setup and runtime processes are present in the same processor. As can be appreciated, the runtime process and processor may be a separate embodiment. Similarly, the other processes such as the several setup processes or preprocessors may alternatively be several separate embodiments with only the required equipment.

The system includes several security levels to control access to parameter files. The most limited access is the User Level that allows the user to run the program and print the job. The next level of access is the Advanced User. This level of access allows the user to operate as a regular user, to have the ability to change the layout of the reports and to have limited set up access such as manipulation of the file name and maximum number of pages. The next level of access is the Setup User that allows access to changing the setup parameters. Finally, the Developer has access to change the underlying code of the reformatting program. It is not necessary that access be defined as above, however, it is to be appreciated that levels of security may be provided to the system.

The document reformatting system of the present embodiment uses setup data tables to control the importation process to read the input print stream or text file and to direct extraction of information from the input for storage in a set of data base tables. The database program utilized in the present embodiment is Microsoft ACCESS® and facilitates the use of calculated controls in a report.

During the import setup process, a setup user is prompted for answers to a series of questions in order to define the import process in addition to general job processing parameters. During the report setup process, the setup user is able to define the output characteristics including the location of graphics, common document information and document specific line item information. In the OMR setup process, the setup user is prompted for answers to a series of questions in order to define the OMR codes to be used and the location of the OMR code in the report.

During the job processing or report generation process, a user or advanced user may be prompted for job run parameters and the input print stream or text file is processed to create the modified print stream or print streams. The setup parameters and the current output file data and information regarding the current page are utilized to select control indicia included as OMR marks in the printed file for the current mail piece. Many document or mail piece handling systems may be utilized. Accordingly, a particular folder/inserter may utilize certain OMR codes. Additionally, differing mail streams may utilize different OMR codes with the same equipment. For each supported document handling equipment, the system stores a set of questions to prompt a user with. Alternatively, the parameter set up tables allows a user to select pre-configured settings or create OMR profiles from predefined codes. As can be appreciated, new code sets can also be defined and utilized.

The information imported from an input stream includes common information such as fields that are expected to be present for each document. The import information also includes line item information that may include a variable number of items for each document. Additionally, the information may include destination addresses that may be stored for each mail piece such that documents in a job going to the same recipient may be combined into a single mail piece. A customer number or other data field or fields may be the database key for coordinating the tables.

Accordingly, setting up the import process is easily accomplished. The import setup process prompts the setup user for answers to several questions. Typical text files include four types of data. The first type of data is common information such as document header information, often printed in the top section of each page. For example, header information may include the date, document number, salesperson's name, etc. It may also include the name and address of the recipient of the particular document. The second type of information that is typically found within the text file is variable information. Variable information includes line items, such as data, which may represent a service performed by an office or an item bought at a store. The third type of data is footer information, such as totals often found only on the last page of a document. The fourth type of information is the destination address information that includes the recipient name and address. The import parameter setup tables of the present embodiment define the layout of the input file. The answers to the setup questions are used to store import setup parameters in data base tables. The import setup parameters are used to control where from the input file to retrieve information, as well as to control the import process. For example, the set up parameters can be instructed that the first five lines of the document include header information, the next 20 lines include variable information, as well as the end point of the pass. Document fields are defined in the import setup process and the import parameters control the location to import the text for those fields.

Once the input file layout and setup parameters have been defined the import process is run and creation of a set of data tables is controlled by the setup parameters. These data tables, for example, include common information, line items, and destination addresses. The set up parameters instruct the program to extract the appropriate information, from the input file and store the data in the proper data table. These data tables are linked such that after the information is manipulated the documents created by a report generator contain the appropriate and related information. For example, each document in the input file is assigned a document number and an address number. The document number provides a link between both the line items and the common information, while the address number links the common information and the destination address. Therefore, when the stored information is accessed during report generation, the tables are linked such that the report contains related information.

The address data table may be optionally exported to address quality (address cleansing) software for postal coding and presorting. Address quality programs include programs such FINALIST® and SMART MAILER® manufactured and distributed by Pitney Bowes Inc.®, of Stamford, Conn. These products enable address cleansing, and postal coding and presorting, which result in potential qualification for postal discounts. Once complete the data is imported back into the destination address data table. A report is then created using a standard report generator such as that included with Microsoft ACCESS®. The report may then be sent to a printer and document finishing system for processing into a mail stream.

During the import process an address number or other identifier is assigned to each unique mail piece and address. If the system imports a document for an identical client identification number or other identifier, the same address identifier is used. Other duplicate identification processes may be used. Accordingly, if while importing the program observes that a duplicate address is being imported, it assigns the document the same address number, however, each document is assigned a different document number. During presort the documents are placed in print order proximity such that during report generation the documents having the same address are printed sequentially so that they can be placed in the same envelope as a single collation and single mail piece.

The user then generates a report representative of the desired print output. Such report generation may be accomplished using Microsoft Access® or a similar report generator. Any changes a user desires to make to a report may now be easily made at the report generation step. Accordingly, the user is no longer required to return to the program that produced the text file to make final report layout changes.

If a document does not have too many pages it may then be sent directly to a printer, saved for later use or transmitted electronically. The reports may be processed by a mail piece finishing system such as DocuMatch® manufactured by Pitney Bowes Inc., located in Stamford, Conn. These mail piece finishing systems properly address, and bar-coded mail pieces, as well as, enable pre-print sheets or inserts to be added to the envelope of a mail piece.

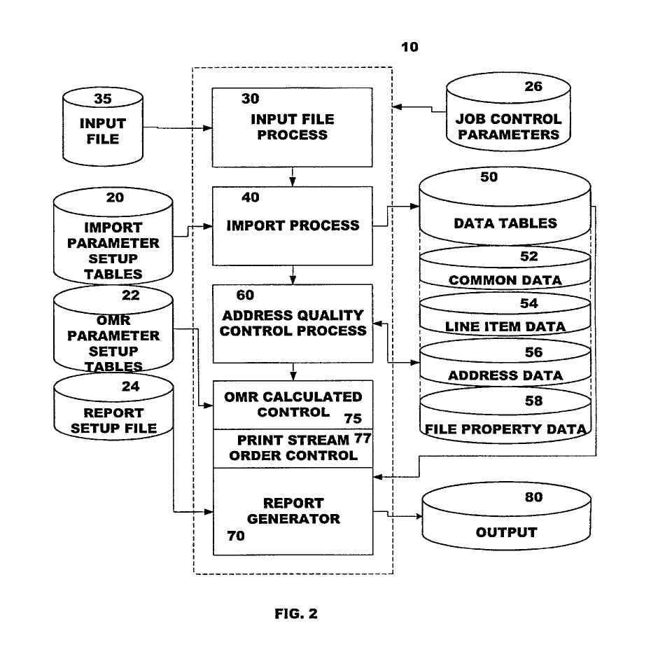

Referring to FIG. 2, a block diagram of an embodiment describing a runtime process for a text file reformatting system is shown. System 10 includes and input file process 30. The input file process 30 reads the input file 35. Input file 35 is preferably an ASCII print stream. An original document generating system such as a mini-computer accounting program may provide an output file or print stream file with information to create documents that are to be processed into mail pieces. Such files may be transported by a Local Area Network, direct modem connection or even by floppy diskette. Any file transfer method may be utilized to obtain the input file 35. Certain original document generating systems may be able to produce differing output files to accommodate differing printers or for other reasons such as compatibility with other systems. Accordingly, the document generating system should be set to produce a compatible file output such as an ASCII file output or a print stream set for a printer with a simple file interface such as one that requires ASCII text based files. Certain AS400 and Unix environment document generation systems such as medical billing systems produce Postscript vector based output, PCL output with downloaded fonts or IBM AFP and IPDS print streams. However, such systems often provide for print stream output with ASCII based filed that utilize only printer fonts. In other embodiments discussed below, the input file process 30 includes a pre-processor for parsing the more complicated formats.

Job control parameters 26 are entered by the setup user or by the advanced user at runtime. They control several runtime parameters including whether the system runs in a batch mode without prompting the user for information, whether the system will use address management and whether the job will be split between at least two printers. Import parameter setup tables 20, which are created by the setup user such that the setup parameters define the required fields from input file 35 and control import process 40. The OMR parameter setup table 22 controls the OMR Calculated Control 75 that modifies the output file report generated by the report generator 70 from import data tables 50.

Input file 35 may be an ASCII or similar text file that is output from a typical accounting system. Typical text files may exist or they may be specifically created for this application. Such files may exist for a wide variety of applications, such as for the generation of medical bills, purchase and sale documents or textual reports. Import parameter set up tables 20 define the layout of input file 35 including, for example, the location of the header, line item and page information. The setup user must define the setup parameters only once for each text reformatting application. An initial data field may define the file type or the name of the file may define its type. Once the layout of input file 35 has been defined, changes to the setup parameters can be easily made. Import Parameter setup tables 20 further include control parameters for identifying where the defined information is to be directed during import 40. The Import definition process is used to define fields for the database, the location in the input file 35 to find the appropriate data and may include key relationship information for the database.

As import process 40 runs, import setup parameters 20 direct what information is extracted from input file 35 and where the information is to be placed within data tables 50. Data tables 50 include common information data 52 for each document, line item information 54 having a variable number of line items per document and destination address information 56 for each collation or mail piece. Additionally, document and mail piece property data 58 includes document information such as the number of pages that may be imported or derived. Common information 52 includes header and footer information for each document in the input. For example, common information 52 includes any header information such as the date, customer number, salesperson's name, etc. Line item information 54 includes, for example, variable information such as, each services performed by a doctor during a visit, or each item purchased from a store, as well as the respective billable amount for each service or item. Destination address information 56 includes the destination of each mail piece in input file 35.

Related fields provide links between data tables 50. Common information 52 stores a document number and an address number for each document in the input file. If, during the import process the program identifies a second document as having the same address as an address on an input document that has already assigned an address number, that second document is assigned the same address number, but it is given a new document number. The address number links destination address 56 with common information 52. The document number links line item information 54 with common information 52. Destination address table 56 may be operatively connected to address quality control process 60. The information contained in destination address table 56 may then be exported to an address quality program for performing postal presorting, and address cleansing.

The Address Quality Control Process 60 allows a user to accept or decline changes suggested by the Address Quality Program. Address cleansing systems may provide functions to increase the quality of the addresses used in a mailing. As can be appreciated, the system preferably maintains the addresses for the current mail run in a separate table or file to be sent to the SmartMailer program in the appropriate format. Alternatively, the system may support additional address cleansing programs by employing translators to convert the generic address table to the required format.

For example, address forwarding databases often allow a vendor to update a clients address even if the client did not communicate the change directly to the vendor without the delay and cost of address forwarding and notification. Additionally, the address cleansing system may change an address to use the proper abbreviation for postal code or otherwise qualify for a postal discount for a matched address. For example, changing Connecticut to CT is usually a benign change. However, some changes may be more risky. For example, an ambiguous address may be one digit off in a zip code for the listed city. In some systems, the zip code would be “fixed.” However, the zip code may be correct and the listed city could be wrong.

In the present system, the user may be asked questions regarding the level of aggressiveness to use without the user having to know the actual settings involved. Here a job control parameter setting will allow all changes or just the most benign. Other alternatives are possible. For example, a first setting would allow the system to make only the most benign changes and list the other suggestions in a log file to be read later. Alternatively, the system may make the benign changes such as state abbreviations and ask for permission to make any others. Various levels of aggressiveness are possible.

In another embodiment, the address quality control program 60 accepts all changes and the results are re-imported into destination address table 50 for use during report generation 70.

Another Job Control Parameter 26 controls whether grouping is used. If grouping is enabled, multiple documents may be grouped into a mail piece. For example, a customer may have two invoices in the same billing period. If a customer or address identifier is used, the process can determine that two documents should be grouped and the print stream is reordered to print the two documents as a single mail piece. The OMR codes will consider the two documents a single collation.

Another Job Control Parameter 26 controls whether the user will be allowed to split the print job between at least two printers. If enabled, the user is allowed to split the job by document number or by postal sorting trays. The OMR codes are set to reflect the reordered multiple print streams.

Report generator 70 and OMR calculated control 75 then process the report setup file 24 template and the data tables to produce the output 80.

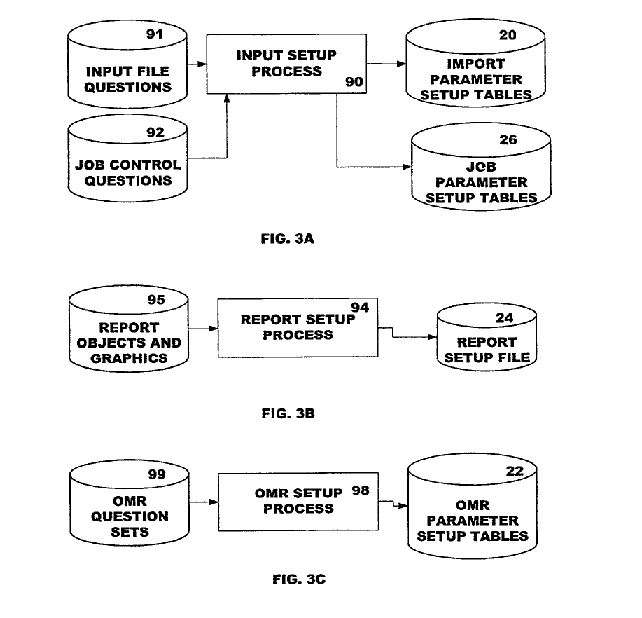

Referring to FIGS. 3A-3C, block diagrams of the setup systems are shown. Security access is described above. In this embodiment, the setup information is input as responses to questions and no programming ability is required of the setup user. The import data is imported into separate tables according to the type of data.

Referring to FIG. 3A, import setup process 90 prompts the setup user with input file questions 91 and job control questions 92. The responses or defaults are used to create import parameter setup tables 20 and job parameter setup tables 26.

Referring to FIG. 3B, report setup process 94 allows the setup user to enter a report design mode and to utilize report objects and graphics files 95 to create a report setup file 24.

Referring to FIG. 3C, OMR setup process 98 prompts the setup user with an appropriate OMR question set 99 for the document handling equipment selected. The responses or defaults are used to create OMR parameter setup tables 22.

As can be appreciated, the OMR code generation process may be involved and require significant programming effort and time to accomplish OMR settings for an original document generation program. Additionally, changes to the document format may then require additional programming. Here, the OMR settings are setup using interactive questions that require no programming skill and that may be easily modified for different document formats and different document handling equipment. Additionally, a user may wish to switch to a more robust OMR feature set. The process of the present embodiment allows such changes to be made without reprogramming the source document generation program.

As can be appreciated, certain document handling equipment and mail piece finishing equipment do not utilize OMR control codes. Accordingly, for settings including the Pitney Bowes Inc. DOCUMATCH system, OMR codes are not used. Similarly, if only envelopes are being printed, OMR codes are not used.

The OMR setup process 98 may be utilized to print debug scan maps showing the marks and the name or abbreviation for the printed marks in order to test the setup. Additionally, the runtime report may be set to create an OMR report to be used to program the document handling equipment.

As described above, an Optical Mark Reader (OMR) is a device that is capable of scanning a piece of paper as it passes underneath it and recognizing the presence or absence of “dark” marks on portions of the paper defined as a scanning channel. In order to provide clear mark indications, it is desirable to use characters that provide as crisp and clear a signal to the sensor as possible. In an ASCII document, a “em dash” or “long dash” line character may be the most easily recognized. Additionally, the underscore (_) or dash (-) may be used. A scanning device reads OMR marks by scanning a defined scan channel of a document. A value may be defined to exist either when the OMR mark is present or when it is absent. A set of OMR marks may be used as a binary counter that may be used in a continuing loop sequence and may also be set to skip the set of marks assigned to zero.

In a 5 Series Tabletop Inserter, the length, thickness and quality of the mark determine if it will be read accurately. Typically, when a solid unbroken high quality line is used, the thickness of the line can range from 0.007″ to 0.025″ in thickness. If a broken line (such as dashes) are used, then the thickness of the line must be 0.010″ to 0.025″ thick. The maximum thickness requirement is determined by the desired 5 to 1 mark to blank space ratio and the line spacing ranges from 0.125″(8 lines per inch) to 0.167″(6 lines per inch). Typically, the length of the line must be a minimum of 0.4″. The quality of the line refers to the smoothness of the edges and of the density of the ink throughout the line. The OMR channel may be on either side of the document and the system must take into account the accumulator stacking sequence that may preserve or reverse sequence. Additionally, the direction of paper travel must be considered.

OMR codes are often used for handling variable page collations. A collation is an assemblage of one or more associated sheets or inserts into a mail piece package suitable for insertion into an envelope. Additionally, OMR codes may be utilized to provide improved collation integrity. OMR codes may provide personalized equipment control such as providing a particular insert to overdue bills. OMR codes may also be used to control the merger of print streams printed to multiple printers.

The full code set is not always utilized and the utilized codes must typically be arranged according to a position hierarchy that may begin with a Bench Mark (BM). Code set capability may be organized into capability hierarchy levels such that the base level enables certain functionality and each higher level of capability includes the features of the lower levels and additional features. Accordingly, a document handling device may support levels of OMR capability as options. For example, in a 5 Series Tabletop Inserter, OMR level 0 consists of the End of Collation (EOC) mark. Level 1 provides for improved collation integrity providing up to six additional marks including Benchmark (BM), End of Collation (EOC)(Presence or Absence setting), Beginning of Collation, (BOC), Divert to Deck (DV), Parity (Odd), and Safety. Level 2 incorporates select feeding capability for controlling the document handling equipment. Level 3 incorporates Document to Document Matching (MC)(2 or 3 additional marks) and Wrap Around Sequencing (WAS)(2 or 3 additional marks).

The Beginning of Collation Mark (BOC) is a mark that indicates the sheet/insert being processed by the sheet/insert feeder module is the first piece fed for the current collation. This is used for error checking purposes only and provides additional verification that pieces from one collation are not being split or combined with another collation into one package.

The Bench Mark (BM) mark is used to indicate the start of a group of multiple marl<s (OMR level 1, 2 & 3 only) and verifies that the scanner is operating correctly. It is the first mark presented to the scanner on every page scanned in a collation.

The Divert to Deck Mark (DV) is allocated and printed on all pages of the collation, that indicates the completed collation should be diverted onto the deck of the base unit, and not sealed or passed out through the end of the base into the stacker. It is often used for periodic samplings of processed mail for manual inspection or as an indicator for ZIP breaks.

The Document to Document Match Marks (MC) are two or three marks that are used to uniquely identify pages of a particular collation. They provide a binary pattern that must be matched on all pages of a collation fed by the control document feeder and support ascending & descending sequence values as well as a pseudo random order. The marks may also be used on subsequent OMR equipped feeders within a system to provide feeder-to-feeder matching capability.

The End of Collation Mark (EOC) is a mark that indicates that the sheet/insert is the last page fed in a collation. If absence of a mark represents the end of collation, a mark must be placed in the correct location on every sheet except the last sheet/insert in the collation as read by the scanner. Absence of EOC provides a greater level of integrity against insertion of multiple collations and is recommended.

The Parity Mark (PAR) is used to provide an internal check on the scan of a set of marks on a single sheet/insert. When parity is active, the total number of marks printed on the sheet must be odd.

The Safety Mark (SF) is an extension of the bench mark in verifying the scanner is operating properly. When the safety is active, the allocated mark location must have a printed mark. This condition will be the same on every OMR scanned sheet/insert within the collation.

The Select Feed Marks (FD) are read from a control document and indicate which of the downstream feeders is enabled to feed material to a collation. A downstream selectable feeder will feed if it is programmed to respond to a designated mark. The mark must be present on all pages of the collation fed from the control document feeder.

The Wrap Around Sequence Marks (WAS) assure that the material is presented to the inserter in the same order that it was printed. Any sequence break will result in an immediate notification of the operator via a system stoppage. This OMR feature supports 2 or 3 bits of ascending or descending sequence values, as well as, the use or non-use of 0 as a sequence value.

In general, marks that apply to an entire collation such as Divert to Deck, Select Feed, and Document to Document Match codes should appear on every sheet within that collation to be scanned. This increases the integrity of the scanning system that then can identify errors in scanning a single sheet by comparing the results from each sheet to ensure that the marks have been correctly interpreted. Marks such as Wrap Around Sequencing, EOC, BOC and Parity are sheet/insert specific and must be evaluated for each sheet/insert fed. Marks such as Benchmark and EOC are mandatory marks in all cases that employ multiple marks (OMR levels 1, 2 & 3).

Accordingly, a document handling system that is compatible with OMR control codes will have a defined number of valid mark combinations. It is possible for each valid combination to be numbered. Certain combinations will provide higher mail piece integrity, but entail more complex error recovery. The desired functionality may be selected from a set of questions presented to a user that might directly refer to the marks or provide questions that do not necessarily refer to the mark, but define a valid mark combination when the questions are answered or left in a default state.

A Control Document refers to the primary OMR document which contains the necessary OMR marks to define how the succeeding modules in a system control creation of a specific collation during the mail creation process. This document is generally read by the most upstream feeder otherwise known as the control feeder. The control feeder refers to an OMR equipped feeder that performs the scanning of OMR control marks on the control document. There is generally only one control feeder in a system.

In the present embodiment, the OMR codes are defined in a calculated control in a report definition. It is the location of the calculated control that determines where the codes will print. Accordingly, the location of the codes may be easily adjusted. As can be appreciated the report definition may be stored as a report definition in an .mdb file for Microsoft Access.

The OMR codes must be located in a defined scan channel at a defined location. Alternatively, the setup user is prompted for information regarding the location of the codes. The location setup information parameter data is then stored in a table for use during the OMR code generation step of the report generation. Alternatively, the location information may be predefined and the parameters stored in a table.

Other document handling devices may have different defined OMR control code sets. However, the sets may be used to create a set of user questions for each supported device or group of devices. Accordingly, a user may be presented with a choice of equipment and then be presented with questions for that device. The answers are then used to store a parameter setup table for the particular job settings.

When an application has been defined, the mark positions are physically fixed. The report process must not automatically delete blank lines. If necessary, a blank line identification holder may be used. If used in a duplex application where both sides of the sheet are used, a single sheet consists of two pages. If the scanner is on the “even” pages (whether a top scanner or bottom), it may be necessary to include an OMR mark on an otherwise blank page.

Additionally, the OMR setting for the document handling equipment must be configured. A test sheet may have the mark names or abbreviations printed along side the mark and may enable a user to program the document handling equipment to utilize the set of OMR marks programmed into the system.

In another embodiment, the parameter setup information relating to the OMR codes to be used and the location of the codes on the pages is sent to the inserter controller over a communications channel.

The OMR marks provide information to handling equipment that is used for controlling the handling equipment. For example, various configurations of Pitney Bowes Series 5 folder/inserter systems available from Pitney Bowes Inc. of Stamford Connecticut may be utilized.

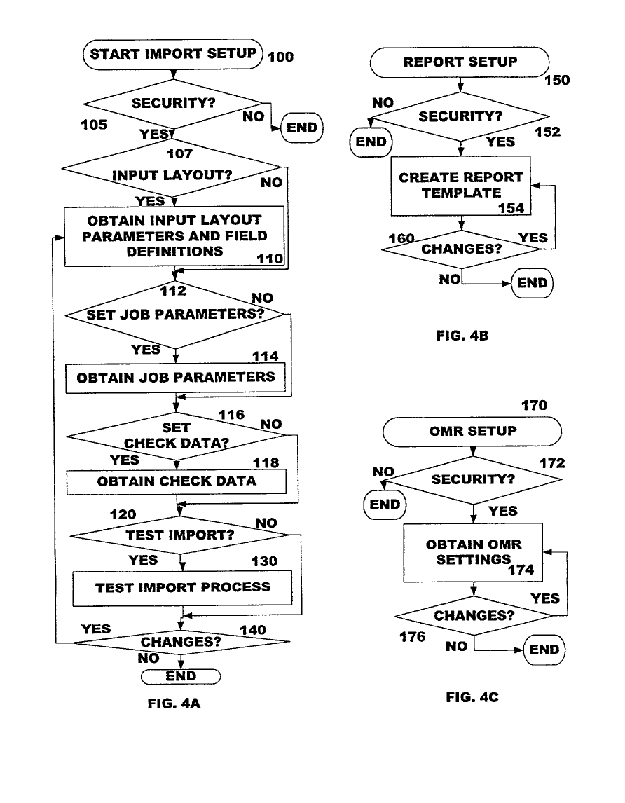

Referring to FIG. 4A, a flow chart describing the import setup process of the present embodiment is shown. The setup process prompts the setup user with questions regarding the input file layout, totals information and grouping, front page information, check data if appropriate, last page information, line item information and destination address information.

In an embodiment, the process is initiated at step 100 and performs a user security level check at 105. If the security check passes, the process continues. Otherwise the process would terminate. If input layout is desired at step 107, the process continues. It continues to step 110 where an input setup question file 91 is used to prompt the setup user for input layout information. During set up, through the use of interactive forms, the user defines the overall layout of the text file including, the line number, starting column, width, and type of each field to extract from the text file. This requires the user to identify in detail where on the text file certain items are located. The process then continues with setup parameters. The file identification can be described in several sections. The first section is the File Items Section. This section may include an Input file, which is the full path and name of the input file, and a job file, which is the full path and file name for the JOB file used for output. A second file identification section may be the Input File Layout Section. This section includes the Lines Per Page field, which is the maximum number of lines per page in the input file. The File Format field is the type of file such as for example UNIX or DOS. The Skip Pages field specifies a number of pages to skip at the beginning of the file while the Skip Lines filed specifies a number of lines to skip at the beginning of the file after skipping pages. Skip Character field specifies a number of characters to skip, after skipping pages and lines at the start of the file. This allows the user to skip print setup stings, which may occur at the beginning of the file. The Line Items Style field allows the layout of the line items section of the input file and the Line Items Start field specifies the starting line number of the line items. The Maximum Line Items field is the maximum number of lines items on a page in the input file while the Lines Per Items field is the number of lines for each item, including any blank lines separating the line items. The Total indicator field defines a test string that marks the beginning of the footer information. Line Item End field specifies the ending location of the line items relative to the Total indicator and is used to stop line item processing above floating totals. The Last Page Indicator Position identifies a text string that marks the last page. This may also be a fixed or floating position. Line Items Per Printed Page field allows the system to know how many pages will be printed for each document.

Custom fields are defined using prompts for information regarding Field Name, line, Start col., Width and Type. Address information, line item information and common information may be defined using similar questions.

Another section to be entered in the setup parameters is information about fields that are used to control the importing process. The Total and Grouping field includes the line number, starting position, and width for a numeric filed used for combining items in one envelope. This grouping enables documents that should be sent to the same address to be grouped together. The Document Break Indicator is a text string that marks the first or last page of a document in the input file, while the Total Indicator is a text string that locates the totals section on the last page of the document. The Total indicator may be set to be a fixed position or a floating position. If Total Indicator is fixed, then the given number indicates the beginning of the total section and the rest of the information is ignored. If the total indicator is set to float, then the line number is ignored and the page is searched from the start of the line items down to find the given text.

Yet another section defined in the parameter setup, is the First Page section. This defines the fields that are to be extracted from the first page. The Field Name defines the name the user wishes to assign the field and the Line Number indicates the line number on the page where the item appears. The Starting column defines the column number of the first character of the field. The Width communicates the width of the data items in the columns. Type specifies the data type for the filed such as text, date, integer lower case, single, double, currency or Boolean.

Other parameters table sections include the Destination address section, the Last Page section and the Line Items section. The Destination Address field defines the destination address lines that may be run through an address quality program. An example of an address quality program that may be applied is FINALIST®, or SMART MAILER® available from Pitney Bowes Inc. of Stamford Conn., which verifies, standardizes and corrects address elements and appends postal codes. Such programs prepare mailing addresses for automated handling through the USPS, allowing mailers to qualify for postal discounts, as well as, to reduce costs due to delayed delivery and undeliverable-as-addressed mail. Another section, the Last Page section contains fields extracted from the last page, while the Line Items section define fields to be extracted from the line items section of the input file.

Next, the system determines in 112 if job parameters are to be set. Such parameters include control parameters that are obtained in 114.

Next, the system determines in 116 if check parameters are to be set. Such parameters include industry standard check related parameters for check-printing applications such as check number, payee and amount that are obtained in 118. As can be appreciated, security access level may be modified for check applications and check reprinting may require a higher access level than normal reprinting for error correction. Security logging and data protection may be used.

After the setup is completed at step 120 the method then proceeds to step 130 where the import process is tested. The method proceeds to step 140 where it is determined as to whether or not any errors occurred during the test import. If an error did occur, then the method returns to step 110 where the set up parameters are again defined. This process continues until at step 140 it is determined that there are no errors. If there are no errors, the import setup is complete.

Referring to FIG. 4B, a flow chart describing the report setup process of the present embodiment is shown. The report setup process begins at 150 and has a security check 152. The setup user may utilize the report tools to create an appropriate report 154. The setup user may test the report and decide whether to make changes 160.

Referring to FIG. 4C, OMR setup is shown. OMR parameters for the finishing equipment are defined beginning in step 170. A security check is performed in 172 followed by OMR related questions for the setup user in 174 based upon the equipment used and a check for required changes 176 that may include printing test pages for scanning.

The parameters may be predefined for a particular model of finishing equipment such as a 5 Series™ Tabletop Inserting System available from Pitney Bowes Inc. of Stamford, Conn. The OMR profile may be defined separately for particular subsets of data files or may be universal for a particular piece of equipment. As can be appreciated, a company may utilize more than one mail piece production line having different equipment. In another embodiment, the OMR profile for a type of file may include alternatives that are automatically selected based upon an input of the mail piece equipment being used. Accordingly, alternative profiles may be stored. The setup user may be prompted by questions pertaining to the Feed order and applicability of each OMR control code.

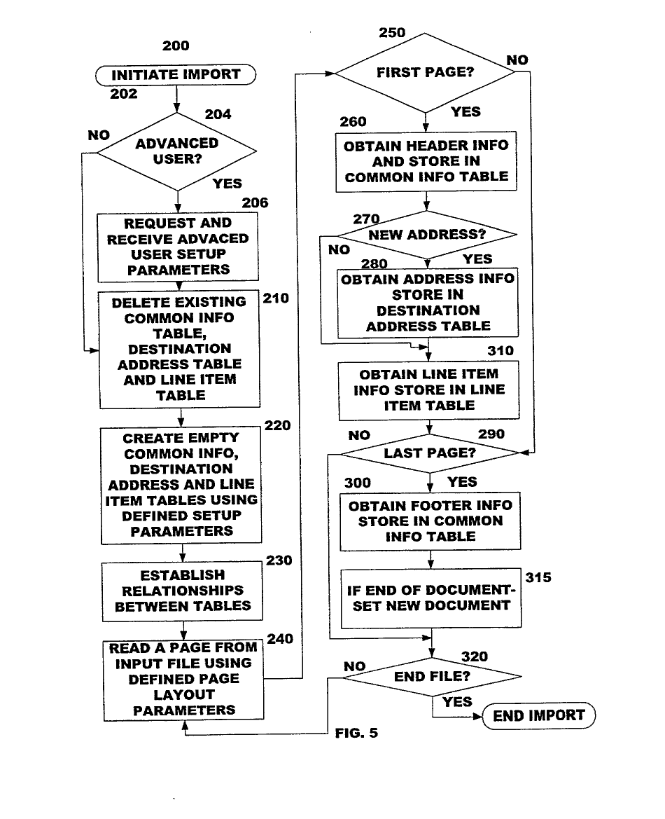

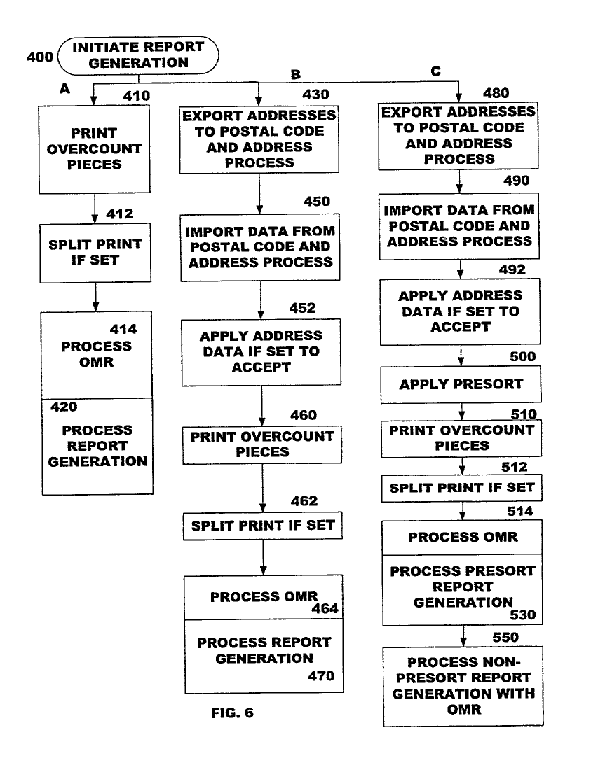

During normal operation the required setup processes are performed once for a type of document to be processed. Then each time the program is run it can proceed to the import process of FIG. 5 and followed by the runtime report generation as shown in FIG. 6. A set of test input data and setup parameters are also preferably provided for training purposes.

Referring to FIG. 5, the import process of the present embodiment is shown.

The import setup parameters include information regarding the following parameters: Input file name, Mail job file, Maximum pages, Print job splitting, Address Program path, Job Type (document handling equipment choice), Scan Map (OMR code names used), Input file lines per page, Input file format (DOS/UNIX), Pages to skip at start of file, Lines to skip at start of file, Characters to skip at start of file, KeepAll to keep blank line items, Starting line for line items, Ending line for line items on last page, Last line for line items on first or middle pages of multi-page documents, Lines per line item, Total indicator position, Document break indicator location, Document break indicator position, Document break indicator style (if indicator is on all pages but the last) and Line items per printed page. The other custom common information, line item information and destination address information fields are also defined.

The import process 200 is initiated at step 202. The process checks for advanced user privileges in step 204. As an optional side step, if the user is an advanced user, the process 200 prompts for advanced user setup parameters including the location of the data file, whether split printing will be used, etc. The method continues to step 210 where any existing common information, destination address or line item information is deleted from the working memory tables. The method then progresses to step 220 where empty common information, destination addresses, and line items tables are created using defined setup parameters.

Common information includes document header and footer information. The common information table maintains one record per document. For example, common information includes the name and address of the user, and any header information. Line item information includes, for example, variable information such as each service performed during a doctor's visit, items purchased from a store and the billable amount for each service or item. Each line item information table maintains one record for each line item entry. Destination address information includes the address for the destination of each document. The destination address file maintains one record for each address. For example, there may be several documents having the same address; however, the destination address maintains only one record of the address. In an alternative embodiment, the address is stored for each document.

The method then progresses to step 230 where a relationship is established between the tables. The data tables are linked by related fields that may be defined during setup. During import an address number and a document number is assigned to each document. If, a second document is identified as having a duplicate address, that document is assigned the same address number, but a new document number is always assigned. The address number links destination address with common information, while document number links line item information with common information.

The method continues to step 240 where a page from an input file is read using defined page layout parameters. The method then continues to step 250 where the method queries as to whether or not the page that was read is the first page. If the answer to the query is “yes,” then the method continues to step 260 where the header information is extracted from the first page and is stored in the common information. The method then proceeds to step 270. If, however, the answer to the query is no then the method proceeds to step 290. At step 270, the method queries as to whether or not the document contains a new address. If the answer to the query is “no,” then the method proceeds to step 290. If however, the answer to the query is “yes,” then the method continues to step 280 where address information is extracted and stored in destination address table. The method then continues to step 310 where line item information is extracted and stored in line item table. The method then continues to step 290 where the method queries if the page is the last page. If the answer to the query is “no” then the method continues to step 315. If however the answer to the query at step 290 is “yes,” then the method continues to step 300 where footer information is extracted and stored in common information table. If the end of document is determined in 315, the process is set to start a new document. The method then continues to step 320 where the method queries as to whether or not the end of the file has been reached. If the answer to the query is “yes,” then the import process ends. If, however, the answer to the query is “no,” then the method proceeds to step 240. This process continues until at step 320 the end of the file has been reached. The process can also process a group of files and end after the last file in a group.

In an alternative embodiment, any OMR required import fields are extracted from the input documents.

Now tuning to FIG. 6 is shown beginning at step 400 the possible processes after import has occurred. As can be appreciated, in a batch mode, the system would continue to the report generation process without input from a user.

If a user does not wish to utilize address correction processes and postal code discount processes such as bar coding or sorting, the user may process a job using path A.

Proceeding down path A to step 410 where the user selects to print any over count pieces that exist. Over count occurs when the report contains too many pages for the designated document-finishing equipment to process. The over count parameter may be set in the setup question and answer session or may be preprogrammed for a particular document finishing equipment configuration.

The method then continues to step 412 where the process determines if split printing is enabled. If split printing is enabled the user is presented with split options including whether to split the job by sequential document numbers or postal sort data. As can be appreciated, the output reports for each collation are configured into a print stream or streams based on that split information. In step 414 a calculated control is utilized during the report generation process 420 to determine the OMR code required for each page. As can be appreciated, OMR codes may not be utilized at all or may be used on only certain pages as in duplex printing where a sheet may contain two pages. In step 420 the machine processable pieces are selected and printed.

If a user does wish to utilize address correction processes but does not wish to use presorting of the mail pieces, the user may process a job through path B.

Alternatively, the method may proceed down path B to step 430 where the import process result is sent to a postal coding program and postal address cleansing program. Postal coding programs are known therefore a detailed description of a postal coding program is not necessary for an understanding of this invention. The method continues to step 450 where the address and postal code data are imported. The proceeds to step 452 where the process applies address change data if set to accept it.

The method continues to step 460 where the over count pieces are printed. The method continues to step 462, 464 and 470 to process the report generation as described above for steps 412, 414 and 420 respectfully.

In another alternative the method continues down path C where the machine process pieces are exported to a postal coding program and presorting is used. The method continues to step 480 where the addresses are exported to be cleansed and postal coded. In step 490 the postal code and address data is imported, and in step 492 it is applied if set to accept such data. The method continues to step 500 where a presort process is applied. The method proceeds to step 510 the over count pieces are printed. In step 512 the split print is processed and will allow a job to be split by postal sort or other criteria. Processing pieces such as pieces having a divert to deck code on presort boundaries can be implemented to allow the user a convenient break point. Such control codes are implemented by OMR process 514. The method then continues to 530 where the presort pieces are processed into print streams. The method then continues to step 530 where the pieces that were rejected during presort are processed into print streams. The method then continues to step 550 where the non-presort pieces are printed.

As can be appreciated, the Access 2000 report generation allows the reformatted print stream to be configured for a variety of supported printers or file types. The OMR process in this embodiment is implemented as a calculated control in Visual Basic for Applications (VBA) using Microsoft Access. When a job report is run, the calculation routine of the calculated control reads the setup parameters, information related to the current page of the report being processed and data extracted from the input file for the current mail piece to control which marks will be printed. The report is setup with an OMR mark location. For example, if a wrap around sequence is being used, the OMR process will keep a scratch pad running count of the sequence in order to know what mark to print next. As can be appreciated, the calculated control has logic regarding the OMR codes available for a particular equipment. It determines the feed direction, duplex status, presence or absence indicators, page numbers, mail piece counters, parity and presence of the available marks. It will calculate which marks are required on a page and insert them according to the proper mark hierarchy.

In this embodiment, the first page of each output report includes an output version of the enabled OMR marks and a scan map that shows the name of each mark. The current set of configuration parameter options is also output on the first page. However, in other embodiments, the system may directly input such information into the processing equipment, but a user may utilize this printed page to confirm or independently set the configuration of the processing equipment such as the inserter. The inserter may require manual configuration and this printed page may aid a user in such configuration.

In another embodiment, a batch mode job processing flag is set. While the system typically prompts the user to answer certain questions, if a batch mode is set, the system will read the required information from a setup file and process the print stream in a predetermined manner without prompting the user for information.

In another embodiment, an Input File Process 30 may include one or more print stream pre-processor processes that may be utilized to condition the output of the document generating system such that an input print stream is first parsed to obtain the required text information. For example, in this embodiment, the system may receive a print stream in HP PCL language and then parse it into text with position information. HP PCL Parsing systems and converting systems are known. As can also be appreciated, bit mapped page information can be processed using the recognition portion of an Optical Character Recognition OCR process to determine text for a page or for a portion or portions of a page. Location information may be extracted as well.

In another embodiment, the input print stream includes a bitmapped or other complicated print stream output with a separate file for each collation or a discernable collation break mark or marks that can be read. The system of this embodiment interrogates the input print stream to determine the collation break indicia if necessary and the number of pages for each collation. Thereafter, the appropriate OMR marks are overlaid into the print stream file in a predetermined location. As can be appreciated, many combinations of original file overlay and scaling are possible.

In another embodiment, an Input File Process 30 may include the import capability of Access 2000. The input file may be a comma delimited file, an Excel spreadsheet file, a database file or other compatible file. The import setup process 90 is then used to define how the input file data is imported into the data tables 50.

In another embodiment, the address data table 56 has an address for each document. However, before data is exported to address quality system by address quality control process 60, any duplicate addresses are removed.

In another embodiment, the outputs 80 generated are checks. In this embodiment, the import setup process 90 prompts the user for predefined fields that are standard fields in the check printing industry. Furthermore, an added level of security is provided for reprint functions that may otherwise be allowed at a user level for error recovery. Additionally, a secondary output file is created that complies with the industry standard Positive Pay file format.

The above specification describes a new system and method for processing information in a data processing system that is useful and may increase throughput speed and/or accuracy of the system. The described embodiments are illustrative and the above description may indicate to those skilled in the art additional ways in which the principles of this invention may be used without departing from the spirit of the invention. Accordingly the scope of the claims should not be limited by the particular embodiments described.

1. A method for modifying a file from an original document generating program comprising:
a) receiving the file having data for at least one document;
b) importing a data set from the file using a set of import parameters;
c) storing the data set in a database;
d) processing said data set using a set of job control parameters;
e) generating at least one report file using a set of output parameters; and
f) outputting the at least one report file.

2. A method for modifying a file from an original document generating program comprising:
a) receiving the file having data for a plurality of documents that are to be sent to a plurality of recipients;
b) extracting a data set from the file using a set of import parameters wherein the data set includes common information for each document, line item information for each document and destination address information for each recipient for sending a mail piece to each recipient consisting of at least one document;
c) storing the data set in a database;
d) determining if document grouping is desired;
e) determining if address cleansing is desired;
f) determining if postal coding is desired;
g) determining if postal sorting is applicable;
h) determine if print splitting is desired and obtaining print splitting data if desired;
i) exporting the destination address information to an address cleansing process if desired modified destination address data;
j) exporting the destination address information to an address coding process if desired and importing modified destination address data;
k) obtaining postal sorting information;
l) sorting the documents by grouping if desired to obtain mail pieces;
m) organizing the documents into mail pieces using print splitting information and postal sorting information;
n) obtaining OMR code setup information;
o) generating at least one report file print stream using a set of output parameters, the data set and the OMR code setup information; and
p) outputting the at least one report file.

3. The method of claim 2 further comprising:
q) determining a sheet limit for each mail piece and organizing the mail pieces to segregate any mail pieces over the limit.

4. The method of claim 2 further comprising:
q) preprocessing the file to obtain an ASCII file.

5. The method of claim 2 wherein the common information and line item information for each document is related to address information for a mail piece using a document identifier and a mail piece identifier.

6. The method of claim 2 wherein the OMR code setup information is selected from a set of code setup information tables that each corresponds to a configuration of document handling equipment.

7. A method for obtaining setup information for an original document generating reformatting program comprising:
a) determining if a user has sufficient security privilege;
b) prompting the user for and receiving common information field definition data;
c) prompting the user for and receiving common information field location data;
d) prompting the user for and receiving line item information field definition data;
e) prompting the user for and receiving line item information field location data;
f) prompting the user for and receiving destination address information field definition data;
g) prompting the user for and receiving destination address information field location data; and
h) storing the data in at least one setup table.

8. The method of claim 7 further comprising:
i) obtaining a report design and storing the design as output setup information;
j) prompting the user for and receiving OMR setup code set definition data;
k) prompting the user for and receiving OMR setup print location data;
l) storing the OMR setup data in an OMR setup table; and
m) testing said setup information.

9. A system for modifying a file from an original document generating program comprising:
a data processor for receiving and processing the file;
a storage device connected to the data processor;
the storage device storing a logic program; and
the data processor operative with the logic program to perform:
receiving the file having data for at least one document;
importing a data set from the file using a set of import parameters;
storing the data set in a database;
processing said data set using a set of job control parameters;
generating at least one report file using a set of output parameters; and
outputting the at least one report file.

10. A system for modifying a file from an original document generating program comprising:
a data processor for receiving and processing the file;
a storage device connected to the data processor;
the storage device storing a logic program; and
the data processor operative with the logic program to perform:
receiving the file having data for a plurality of documents that are to be sent to a plurality of recipients;
extracting a data set from the file using a set of import parameters wherein the data set includes common information for each document, line item information for each document and destination address information for each recipient for sending a mail piece to each recipient consisting of at least one document;
storing the data set in a database;
determining if document grouping is desired;
determining if address cleansing is desired;
determining if postal coding is desired;
determining if postal sorting is applicable;
determine if print splitting is desired and obtaining print splitting data if desired;
exporting the destination address information to an address cleansing process if desired modified destination address data;
exporting the destination address information to an address coding process if desired and importing modified destination address data;
obtaining postal sorting information;
sorting the documents by grouping if desired to obtain mail pieces;
organizing the documents into mail pieces using print splitting information and postal sorting information;
obtaining OMR code setup information;
generating at least one output file print stream using a set of output parameters, the data set and the OMR code setup information; and
outputting the at least one report file.

11. The system of claim 10 wherein the data processor is further operative with the logic program to perform:
determining a sheet limit for each mail piece and organizing the mail pieces to segregate any mail pieces over the limit.

12. The system of claim 10 wherein the data processor is further operative with the logic program to perform:
preprocessing the file to obtain an ASCII file.

13. The system of claim 10 wherein the data processor is further operative with the logic program to perform:
relating common information and line item information for each document to address information for a mail piece using a document identifier and a mail piece identifier.

14. A system for providing setup information for modifying a file from an original document generating program comprising:
a data processor having for receiving the file;
a storage device connected to the data processor;
the storage device storing a logic program; and
the data processor operative with the logic program to perform:
determining if a user has sufficient security privilege;
prompting the user for and receiving common information field definition data;
prompting the user for and receiving common information field location data;
prompting the user for and receiving line item information field definition data;
prompting the user for and receiving line item information field location data;
prompting the user for and receiving destination address information field definition data;
prompting the user for and receiving destination address information field location data; and
storing the data in at least one setup table.

15. The system of claim 14 wherein the data processor is further operative with the logic program to perform:
obtaining a report setup file and storing the file as output setup information;
prompting the user for and receiving OMR setup code set definition data;
prompting the user for and receiving OMR setup print location data;
storing the OMR setup data in an OMR setup table; and
testing said setup information.
